(19) United States
(12) Patent Application Publication
(10) Pub. No.: US 2023/0114226 A1
(43) Pub. Date: Apr. 13, 2023

(54) ROLE MINING PROXIMITY ANALYSIS FOR IMPROVED ROLE-BASED ACCESS CONTROL

(71) Applicant: ForgeRock, Inc., San Francisco, CA (US)

(72) Inventors: Aaron Gauldin, Franklin, TN (US); Sudhakar Peddibhotla, San Ramon, CA (US); Peter Barker, Austin, TX (US)

(73) Assignee: ForgeRock, Inc., San Francisco, CA (US)

(21) Appl. No.: 17/559,911

(22) Filed: Dec. 22, 2021

Related U.S. Application Data
(60) Provisional application No. 63/270,761, filed on Oct. 22, 2021.
(60) Provisional application No. 63/255,319, filed on Oct. 13, 2021.

(51) Int. Cl. H04L 9/40; G06Q 10/06

(52) U.S. Cl. CPC H04L 63/105; G06Q 10/063112; G06Q 10/06316; G06Q 10/063118

(57) ABSTRACT

The disclosed technology teaches a method of coalescing candidate roles discovered by role mining with active roles that preexisted the role mining, including calculating pairwise proximities between the candidate roles and the active roles by counting differences between pairs over attribute lists for entitlement, driving factors and access patterns, with a penalty for lack of overlap between attribute lists to produce a total difference score. Also included is selecting pairs of candidate and active roles that have a low total difference scores that also are below a threshold. For the selected pairs, the disclosed method includes proposing to assign entitlements from the active role to the paired candidate role, and receiving user feedback on whether to proceed with merging of candidate roles in the pair into corresponding active roles, while retaining entitlements of the active roles.

### PRIORITY

This application claims the benefit of U.S. Application No. 63/255,319, titled “Role Mining Proximity Analysis for Improved Role-Based Access Control,” filed 13 Oct. 2021 and U.S. Application No. 63/270,761, titled “Role Mining Proximity Analysis for Improved Role-Based Access Control,” filed 22 Oct. 2021.

The priority applications are incorporated by reference herein for all purposes.

### RELATED APPLICATIONS

This application is related to the following applications:

U.S. application Ser. No. 15/900,475, titled “System for Controlling Access to a Plurality of Target Systems and Applications,” filed 20 Feb. 2018, now U.S. Pat. No. 10,708,274, issued 7 Jul. 2020; and

U.S. application Ser. No. 16/016,154, titled “System for Controlling Access to a Plurality of Target Systems and Applications,” now U.S. Pat. No. 10,686,795, issued 16 Jun. 2020, which is a continuation in part of U.S. Ser. No. 15/900,475.

The related applications are incorporated by reference herein for all purposes.

### FIELD OF THE TECHNOLOGY DISCLOSED

The technology disclosed relates generally to access to computer resources by users within an enterprise. More specifically the disclosed technology relates to improving role-based access control by coalescing candidate roles discovered by role mining with active roles that preexisted the role mining, utilizing machine learning based insights to compose and help users build functional roles.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

To grant user access through a simple functional role is a very appealing concept. An employee joins a firm with specific job duties, and a functional role that mirrors those job duties automatically provisions access required for those job duties. The access includes accounts in all applications that user should have access to and entitlements, also known as permissions, within that application. The hope for simplifying access drove a huge investment in Role Based Access Control (RBAC).

The world has pursued this goal to build a set of functional roles for over a decade and all but failed. The huge volume of permissions to analyze, the human bias introduced in establishing these functional roles, and the constant churn of the access landscape has led to very few success stories, if any, in implementing automatic access. To address such a problem, Autonomous Identity provides a novel approach to utilize machine learning to review the entire access landscape and provide a path where user's human resources (HR) attributes drive access to specific permissions. The disclosure for this approach is a subject of “System for Controlling Access to a Plurality of Target Systems and Applications” which is a related patent application by the applicant, which is incorporated by reference for all purposes, as described above.

Though RBAC has mostly failed, the lure of being able to simplify access through a set of functional roles has not. Business is constantly changing, personnel are constantly changing, and what access they need can change too. With goals of reducing over-provisioning of access, decreasing risk exposure, and identifying bad access more quickly, there is a desire to create efficient roles and to automate the process.

An opportunity arises for coalescing candidate roles discovered by role mining with active roles that preexisted the role mining, utilizing machine learning based insights to compose and help customers build functional roles, via autonomous identity-based access control (AIBAC) instead of RBAC.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings.

FIG. 1 shows an architectural level diagram of a system for coalescing candidate roles discovered by role mining with active roles that preexisted the role mining, according to one embodiment of the disclosed technology.

FIG. 2 shows a block diagram of a system for coalescing candidate roles discovered by role mining with active roles that preexisted the role mining.

FIG. 3 illustrates a user interface for autonomous (auto) ID engine that an analyst can use to create a job to run “Role Mining”.

FIG. 4 shows a user interface for reviewing candidate roles, using roles workshop.

FIG. 5 illustrates a user interface for analyzing a specific role for publication.

FIG. 6 shows a disclosed user interface for demonstrating roles, creating drafts and evaluating changes to published roles.

FIG. 7 is a simplified block diagram of a computer system that can be used for coalescing candidate roles discovered by role mining with active roles that preexisted the role mining, according to one embodiment of the disclosed technology.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Companies need to know who/what is asking for access to an application or service, need to be sure that the user is doing something expected from a location that they would be expected to be in, and want the user to only be doing something they should be doing. In one example, a corporate VP on a mobile phone, at home on their own Wi-Fi network, after hours but not too late, wants to check Salesforce (SFDC) for some numbers. The transaction seems safe and is allowed. However, if something changes during the session, such as an attempt to access the source code repository for the company software product now from a different IP, then something might not be quite right. In this example, we would want to ensure that the VP is still the VP, and ask them to confirm who they are and to re-authorize themselves, with a biometric signal such as Face ID.

Large multi-vendor cloud applications utilize zero-trust policies, with trust boundaries between application services, to avoid compromising security standards. “Zero trust network access (ZTNA) is a product or service that creates an identity- and context-based, logical access boundary around an application or set of applications. The applications are hidden from discovery, and access is restricted via a trust broker to a set of named entities. The broker verifies the identity, context and policy adherence of the specified participants before allowing access and prohibits lateral movement elsewhere in the network” (Gartner).

Role-based Autonomous Identity (AI) based access control (AIBAC), as disclosed in this document, is needed for several reasons. Roles that are stagnant allow access to applications which should not be allowed. Sometimes, outdated roles are never deleted in the system and many times this creates back door ‘keys to the kingdom’ for the bad guys. Role and entitlements can explode over time at a growing enterprise, which can lead to many access approvals, and certification rubber stamping and overprovisioned user access.

The disclosed technology addresses the concerns described above, offering enterprise-wide access landscape visibility, contextual user access insights, quicker access request approvals, automation of access reviews and entitlement cleanup. The disclosed role-based Autonomous Identity can be utilized to eliminate certification rubber stamping and reduce role maintenance and remove unused roles and entitlements. Use of the disclosed technology can support organizations to reduce unauthorized access, achieve regulatory compliance, avoid financial and audit fines, decrease data breach risk, reduce costly project delays, avoid reputational damage, and eliminate inappropriate access privileges across the enterprise.

The applicant's Autonomous Identity (AI) discovers role-based access patterns across the organization and recommends optimized role structures, to reduce enterprise risk. These specific role recommendations help ensure that users have the level of access they need while increasing the organization's security posture. With AI, organizations can effectively enforce least privilege access that restricts access to only the resources require for an employee or a contractor to do their job. The disclosed dynamic approach implements the “trust nothing, verify everything” model that further minimizes the attack surface from insider and external threats.

The applicant discloses algorithms that compose functional roles, building on a novel approach to build association rules, as disclosed by the applicant in the application, “System for Controlling Access to a Plurality of Target Systems and Applications,” listed above, and leveraging the association rules to build functional roles.

An enterprise can use Autonomous Identity (AI) to get a set of association rules that allow the company to remove human bias involved in provision access, and unlock automation potential, thus helping customers realize lower risk and dramatically reduced costs. The association rules are unbiased and a result of analysis of global access, and contain the key ingredients for building the functional roles that hold appeal across the industry.

The applicant discloses two sets of algorithms for converting the association rules into enterprise roles. The first algorithm is the role mine candidate role algorithm that receives as input the collection of association rules, and builds a set of candidate functional roles. A customer can then take these candidate roles, modify them as needed, and publish them for overall consumption by the business. The second algorithm, the role mine proximity algorithm, utilizes successive runs of the role mine candidate role algorithm for establishing proximity of the newly constructed functional roles to the roles that may have already been published by the customer. The role mine proximity algorithm allows customers to learn whether their existing published functional roles require modifications to evolve with business changes.

The next section describes an environment for coalescing candidate roles discovered by role mining with active roles that preexisted the role mining.

### Architecture

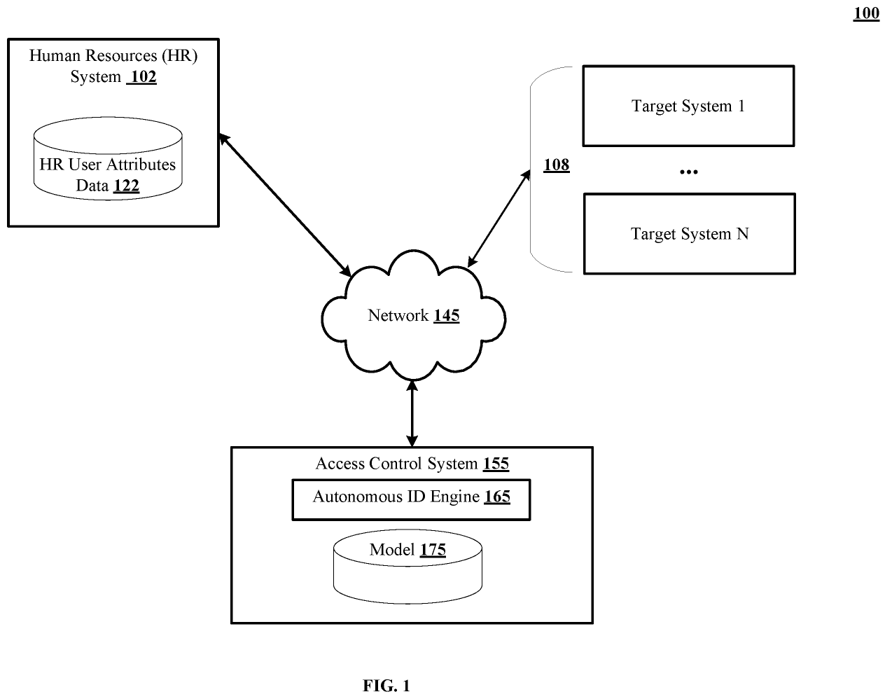

FIG. 1 shows an architectural level diagram of a system 100 for coalescing candidate roles discovered by role mining with active roles that preexisted the role mining. Because FIG. 1 is an architectural diagram, certain details are intentionally omitted to improve clarity of the description. The discussion of FIG. 1 is organized as follows. First, the elements of the figure are described, followed by their interconnections. Then, the use of the elements in the system are described in greater detail.

System 100 includes devices and systems that facilitate control of access to target systems, including human resources (HR) system 102, access control system 155 and target systems one through N 108. Human resources (HR) system 102 facilitates specifying information associated with a user of the enterprise system, such as profile data. HR system 102 is operatable by a user who is associated with the enterprise, such as a human resources administrator. Exemplary profile data may include biographic information, such as a name, user identity and an address, along with enterprise-specific information such as an employment start date, title, grade level, department, manager name, reporting hierarchy, group, years of experience, physical location, and full time/part time designation. Target systems one through N 108 correspond to various computers located throughout the enterprise, configured to perform specific tasks, such as an enterprise resource planning (ERP) system, a customer relationship management (CRM) system, and a supply chain management (SCM) system. Each of target systems one through N 108 may implement a form of access control to prevent unauthorized access. Moreover, each of the target systems may host various applications and each application may have its own form of access control to prevent unauthorized access. As used herein, access to a system and/or an application operating on the system is referred to as an entitlement or privilege. Access control system 155 responds to requests for access, coordinating authentication and consent gathering. Access control system 155 includes model 175 that builds association rules that can be leveraged to build functional roles, and autonomous (auto) ID engine 165 for coalescing candidate roles discovered by role mining with active roles that preexisted the role mining. Details and an example are described later in this document.

In the interconnection of the elements of system 100, network 145 couples HR system 102, access control system 155 and target systems one through N 108 in communication. The communication path can be point-to-point over public and/or private networks. Communication can occur over a variety of networks, e.g., private networks, VPN, MPLS circuit, or Internet, and can use appropriate application program interfaces (APIs) and data interchange formats, e.g., REST, JSON, XML, SOAP. The communications can be encrypted. This communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX.

Further continuing with the description of the system 100, components of FIG. 1 are implemented by software running on varying types of computing devices. Example devices are a workstation, a server, a computing cluster, a blade server, and a server farm, or any other data processing system or computing device. The engine can be communicably coupled to the databases via a different network connection.

While system 100 is described herein with reference to particular blocks, it is to be understood that the blocks are defined for convenience of description and are not intended to require a particular physical arrangement of component parts. Further, the blocks need not correspond to physically distinct components. To the extent that physically distinct components are used, connections between components can be wired and/or wireless as desired. The different elements or components can be combined into single software modules and multiple software modules can run on the same hardware.

Terminology in use in this document includes the following. “Entitlement” is a unit of privilege, and can be fine grained or coarse grained. “Assignment” is the relationship between user and entitlement. A “driving factor” is a high confidence attribute, as algorithmically determined using model 175. The driving factor value is used to determine access. “Justification” is a collection of driving factors, with each driving factor related to each other through an AND relationship. Justification and “access pattern” are used interchangeably in this document. An association rule is the result of using autonomous ID machine learning (ML) that describes the justification for a given entitlement using a confidence score.

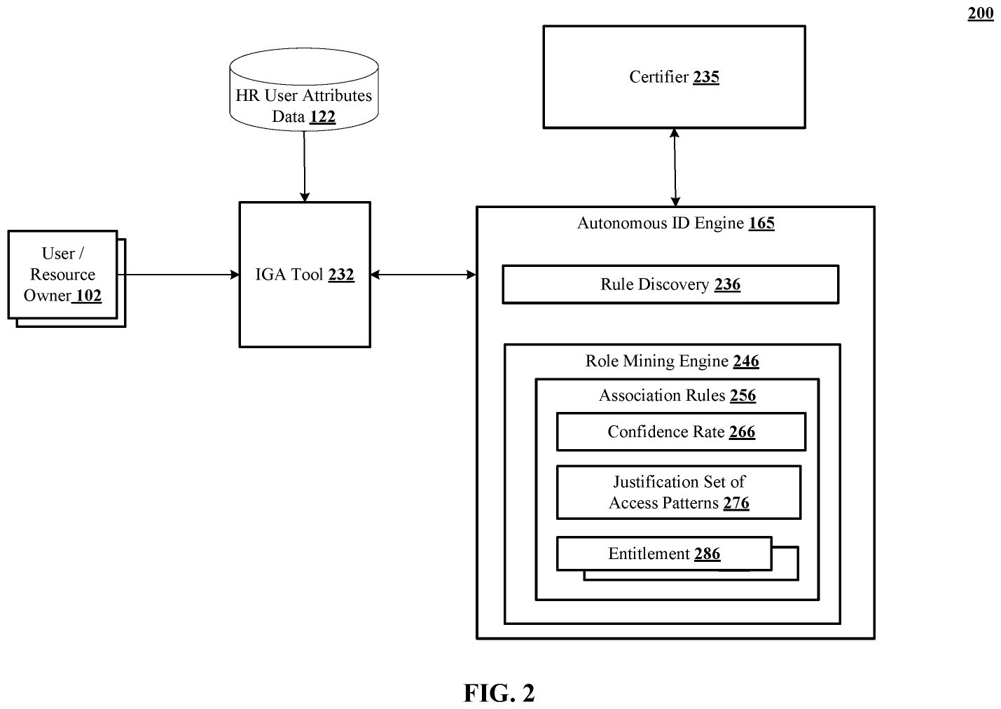

FIG. 2 shows a block diagram of a system 200 for coalescing candidate roles discovered by role mining with active roles that preexisted the role mining. System 200 has user/resource owners 102, Identity Governance & Administration (IGA) tool 232, HR user attributes data 122, autonomous (auto) ID engine 165 and certifier 235. When a user/resource owner 102 requests access to a system or application, IGA tool 232 orchestrates centralized policy-based user identity management and access control, utilizing HR user attributes data 122. Auto ID engine 165 has rule discovery 236 that uses association rules produced by model 175. Association rules 256 include confidence rates 266, justification sets of one or more access patterns 276, and entitlements 286. Confidence rates 266 are algorithmically determined using model 175. In one example confidence rate, of 100 employees who have four specific HR attributes, 85 of the employees have the entitlement assigned to them, resulting in a confidence rate of 85%. Justification sets of one or more access patterns 276 are collections of driving factors in which each driving factor is related to each other through an AND relationship. Entitlement 286 is a unit of privilege.

Two disclosed algorithms turn association rules 256 into enterprise roles. A role includes an entitlement set 286 with its associated justification set 276, in which each justification within the justification set is related to each other justification in an “OR” relationship. The role mine candidate role algorithm receives as input the collection of association rules, and builds a set of candidate functional roles. Role mining engine 246 utilizes association rules 256 which allow removal of human bias involved in provision access and unlock automation potential, which can help customers realize lower risk and dramatically reduced costs. A sample set of association rules 256 for creating candidate roles in a fresh Autonomous ID deployment is listed next.

| Entitlement | Access Pattern | Confidence | Frequency |
|---|---|---|---|
| Ent_A | [AP_1] | .95 | 56 |
| Ent_A | [AP_2] | .85 | 39 |
| Ent_A | [AP_3] | 0.86 | 120 |
| Ent_A | [AP_4] | 0.92 | 55 |
| Ent_B | [AP_1] | 0.97 | 56 |
| Ent_B | [AP_3] | 0.78 | 120 |
| Ent_B | [AP_4] | 0.99 | 55 |
| Ent_C | [AP_2] | 1 | 39 |
| Ent_C | [AP_3] | 1 | 120 |
| Ent_C | [AP_4] | 0.94 | 55 |
| Ent_D | [AP_1] | 0.88 | 56 |
| Ent_D | [AP_5] | 0.25 | 78 |
| Ent_D | [AP_6] | 1 | 3 |

The mining of candidate roles considers a customer-configurable set of thresholds: ConfidenceThreshold, FrequencyThreshold, EntitlementMinimum and StemmingEnabled. ConfidenceThreshold is the minimum confidence for minable AssociationRules, and dictates the lowest acceptable confidence for any access pattern in the set. FrequencyThreshold is the minimum number of identities for minable AssociationRules and dictates the minimum number of users that applicable to any given access pattern in the set. EntitlementMinimum is the minimum number of entitlements in a mined Candidate Role. StemmingEnabled signals to reduce the number of minable AssociationRules by removing those whose justifications have a parent: child relationship.

The first step of the mining process is to reduce the set of minable AssociationRules. This is achieved by applying the thresholds described above, discarding rules with a low confidence, a low frequency, and an unnecessarily high level of granularity (i.e., AssociationRules that have an existing, less complex/less granular, counterpart within the set.) In an example which uses the sample set of rules listed above, the first step in the mining process is to filter the rules by their corresponding confidence and frequency. For this example, we configure ConfidenceThreshold=0.75 and FrequencyThreshold=30. The reduced set of rules achieved by applying the configured thresholds is listed next. Note that one rule is excluded because the confidence is only 0.25 and another rule is excluded because the frequency is only 3.

| Entitlement | Access Pattern | Confidence | Frequency |
|---|---|---|---|
| Ent_A | [AP_1] | .95 | 56 |
| Ent_A | [AP_2] | .85 | 39 |
| Ent_A | [AP_3] | 0.86 | 120 |
| Ent_A | [AP_4] | 0.92 | 55 |
| Ent_B | [AP_1] | 0.97 | 56 |
| Ent_B | [AP_3] | 0.78 | 120 |
| Ent_B | [AP_4] | 0.99 | 55 |
| Ent_C | [AP_2] | 1 | 39 |
| Ent_C | [AP_3] | 1 | 120 |
| Ent_C | [AP_4] | 0.94 | 55 |
| Ent_D | [AP_1] | 0.88 | 56 |

The next step of the mining process is to produce candidate roles, by first grouping entitlements (also referred to as consequents) by their corresponding access pattern (also referred to as antecedent). Group entitlements by access patterns for this example are listed next.

| Access Patterns | Entitlements |
|---|---|
| [AP_1] | [Ent_A, Ent_B, Ent_D] |
| [AP_2] | [Ent_A, Ent_C] |
| [AP_3] | [Ent_A, Ent_B, Ent_C] |
| [AP_4] | [Ent_A, Ent_B, Ent_C] |

Subsequently, access patterns are grouped by their entitlement. Rules with identical entitlements are grouped. This produces the new candidate role set, with candidate roles that group access patterns by entitlements listed below for the example.

| role_id | Access Patterns | Entitlements |
|---|---|---|
| ROLE_1 | [[AP_1]] | [Ent_A, Ent_B, Ent_D] |
| ROLE_2 | [[AP_2]] | [Ent_A, Ent_C] |
| ROLE_11 | [[AP_3], [AP_4]] | [Ent_A, Ent_B, Ent_C] |

The mining process can be run many times with existing active roles to consider. These active roles get mapped to related candidate roles, that are found in subsequent mining executions.

The disclosed role proximity algorithm (RPA) is a means by which newly mined candidate roles can effectively be tied, compared, and related to existing published/active roles from previous mining runs. This process avoids many of the drawbacks associated with deterministic, backwards-looking approaches. e.g., iteratively comparing existing roles to association rules for the tracking/logging of recommended changes. The mapping of active roles to candidate roles is done through performing a proximity calculation. The RPA operates on three distinct role attributes when comparing candidate roles to published/active roles for mapping: entitlements, justifications, and driving factors.

For our purposes, a proximity score is defined as the sum of the set differences across all comparable attributes, including artificial rewards/penalties. In this case, the entitlements, justifications and driving factors attributes are used. We calculate a proximity score between roles by taking the sum of the set difference in the distinct areas. Lower scores indicate a higher proximity between roles and vice versa. That is, a lower proximity score occurs when roles are more similar, and a higher proximity score occurs when roles are less similar. Lower scores indicate a closer relationship/similarity/proximity.

The example continues with a compare between the candidate roles and a set of pre-existing active roles, along with access patterns definitions relative to driving factors, listed below.

Candidate Roles

| role_id | Access Patterns | Entitlements | Driving Factors |
|---|---|---|---|
| ROLE_1 | [[AP_1]] | [Ent_A, | [DF_1, DF_2] |
| | | Ent_B, Ent_D] | |
| ROLE_2 | [[AP_2]] | [Ent_A, Ent_C] | [DF_3, DF_4, DF_5] |
| ROLE_11 | [[AP_3], [AP_4]] | [Ent_A, | [DF_1, DF_6, |
| | | Ent_B, Ent_C] | DF_7, DF_8] |

Active Roles (Pre-existing)

| role_id | Access Patterns | Entitlements | Driving Factors |
|---|---|---|---|
| ROLE_20 | [[AP_1]] | [Ent_A, | [DF_1, DF_2] |
| | | Ent_B, Ent_D] | |
| ROLE_21 | [[AP_2]] | [Ent_A, Ent_C, | [DF_3, |
| | | Ent_E, Ent_F] | DF_4, DF_5] |
| ROLE_22 | [[AP_3], [AP_4], | [Ent_A, Ent_B]] | [DF_1, DF_6, |
| | [AP_5]] | | DF 7, DF_8, DF_9] |
| ROLE_23 | [[AP_1], [AP_4], | [Ent_D, Ent_F]] | [DF_1, DF 2, |
| | [AP_5]] | | DF_8, DF_9] |

| Access Patterns | Driving Factors |
|---|---|
| AP_1 | [DF_1, DF_2] |
| AP_2 | [DF_3, DF_4, DF_5] |
| AP_3 | [DF_1, DF_6, DF_7] |
| AP_4 | [DF_8,] |
| AP_5 | [DF_9] |

Scoring begins by calculating proximity per attribute between the pools of candidate and published/active roles. One point of intersection must exist between roles within the attribute for scoring to take place. For each of these single-attribute role comparisons, the lowest (n) scores are returned per role as mapping candidates.

When all single-attribute scores are returned for potential candidate to publish/active role mappings, they are consolidated to produce a total proximity score per potential mapping. In cases where a mapping does not receive a single-attribute score, it receives a penalty of (P) added to its total proximity score. Altering the value of penalty (P) determines the level of attribute congruency desired by the customer.

Lower Penalty (P)=Flexible role mapping, incongruent attributes allowed (customer option, whose typical value ranges from low to high; For example, 100 represents high, requiring perfect congruence. Ten is a low value, with a lower penalty for lack of multi justification overlap and congruence. Higher Penalty (P)=Inflexible role mapping, high attribute congruence desired.

The proximity between candidate roles and active roles is calculated, with a requirement of at least one point of intersection in entitlements. For areas with no overlap/intersection during scoring, we penalize (P) the mapping with a configurable penalty. For this example, we use a default value of 100. This penalizes mappings with complete divergence in one or more areas: entitlements, access patterns, and driving factors.

Candidate to Active Role Mapping

| | active_ | dscore_ | dscore_ | dscore_ | score_ |
|---|---|---|---|---|---|
| role_id | role_id | ents | ap | dfactors | total |
| ROLE_1 | ROLE_20 | 0 | 0 | 0 | 0 |
| ROLE_1 | ROLE_21 | 5 | 100 | 100 | 205 |
| ROLE_1 | ROLE_22 | 1 | 100 | 5 | 106 |
| ROLE_1 | ROLE_23 | 3 | 2 | 2 | 7 |
| ROLE_2 | ROLE_20 | 3 | 100 | 100 | 203 |
| ROLE_2 | ROLE_21 | 2 | 0 | 0 | 2 |
| ROLE_2 | ROLE_22 | 2 | 100 | 100 | 202 |
| ROLE_11 | ROLE_20 | 2 | 100 | 4 | 106 |
| ROLE_11 | ROLE_21 | 3 | 100 | 100 | 203 |
| ROLE_11 | ROLE_22 | 1 | 1 | 1 | 3 |

In the next step for determining role proximity, we select mappings with a score below a certain configurable threshold. For this example, the threshold is set to 20, which signifies that for an active role to be mapped to a candidate role, the role must have an overlap/intersection in all areas. This threshold is a very conservative configuration, which yields high confidence in the mapping between active roles and candidate roles. Using this configuration value, mappings will only take place if roles are very similar. The results are listed next.

| | active_ | dscore_ | dscore_ | dscore_ | score_ |
|---|---|---|---|---|---|
| role_id | role_id | ents | ap | dfactors | total |
| ROLE_1 | ROLE_20 | 0 | 0 | 0 | 0 |
| ROLE_1 | ROLE_23 | 3 | 2 | 2 | 7 |
| ROLE_2 | ROLE_21 | 2 | 0 | 0 | 2 |
| ROLE_11 | ROLE_22 | 1 | 1 | 2 | 4 |

In the next step for determining role proximity, we select lowest score mapping for active roles, with the results for the example listed below.

| active_ | | dscore_ | dscore_ | dscore_ | score_ |
|---|---|---|---|---|---|
| role_id | role_id | ents | ap | dfactors | total |
| ROLE_20 | ROLE_1 | 0 | 0 | 0 | 0 |
| ROLE_23 | ROLE_1 | 3 | 2 | 2 | 7 |
| ROLE_21 | ROLE_2 | 2 | 0 | 0 | 2 |
| ROLE_22 | ROLE_11 | 1 | 1 | 2 | 4 |

Then, we select lowest score mapping for candidate roles, as listed next.

| | active_ | dscore_ | dscore_ | dscore_ | score_ |
|---|---|---|---|---|---|
| role_id | role_id | ents | ap | dfactors | total |
| ROLE_1 | ROLE_20 | 0 | 0 | 0 | 0 |
| ROLE_2 | ROLE_21 | 2 | 0 | 0 | 2 |
| ROLE_11 | ROLE_22 | 1 | 1 | 2 | 4 |

Role IDs are then coalesced from active roles back onto candidates, with the results for candidate roles for the example shown here.

| role_id | access patterns | entitlements |
|---|---|---|
| ROLE_20 | [[AP_1]] | [Ent_A, Ent_B, Ent_D] |
| ROLE_21 | [[AP_2]] | [Ent_A, Ent_C] |
| ROLE_22 | [[AP 3], [AP_4]] | [Ent_A, Ent_B, Ent_C] |

With total proximity scores calculated for all potential/reasonable mappings, bi-directional filtering takes place to determine which of these mappings are most appropriate. At this point, both published/active and candidate roles may have multiple mappings.

In rare cases, proximity score ties and mapping conflicts occur; that is, a Candidate Role is the lowest scored match for multiple Published/Active Roles. An example is listed later in this document. When mapping conflicts occur, a Candidate will receive a list of these potential Published/Active Role IDs, but no authoritative mapping will take place. A customer can then resolve the role mapping conflict in the UI.

An additional step in the proximity mapping algorithm includes handling of multi-mapping when an authoritative mapping is not possible, using a field in the roles index with a “ties” value. An alternative outcome for the proximity algorithm is when a Candidate Role may have more than 1 matching Active Role. (pre-existing). The potential mapping values in this next example are independent of the values of the previous example described above. ROLE_100 has two possible matches, as indicated by each of the two rows having the same total score in the example listed below.

| | active_ | dscore_ | dscore_ | dscore_ | score_ |
|---|---|---|---|---|---|
| role_id | role_id | ents | ap | dfactors | total |
| ROLE_100 | ROLE_20 | 1 | 3 | 3 | 7 |
| ROLE_100 | ROLE_23 | 3 | 2 | 2 | 7 |
| ROLE_200 | ROLE_21 | 2 | 0 | 0 | 2 |
| ROLE_1100 | ROLE_22 | 1 | 1 | 2 | 4 |

Because of this ‘tie,’ we may not authoritatively conclude that ROLE_100 IS ROLE_20 or that ROLE_100 IS ROLE_23. As an additional step, in these scenarios, the disclosed algorithm populates a field with all suitable mappings for the Candidate.

Candidate Roles

| role_id | Access Patterns | Entitlements | Potential Mappings |
|---|---|---|---|
| ROLE_100 | [[AP_1]] | [Ent_A, | [ROLE_20, |
| | | Ent_B, Ent_D] | ROLE_23] |
| ROLE_21 | [[AP_2]] | [Ent A, Ent_C] | [ ] |
| ROLE_22 | [[AP 3], | [Ent_A, | [ ] |
| | [AP_4]] | Ent_B, Ent_C] | |

These potential mappings are stored in a roles database and may be resolved manually by the user. The user can choose, by preference, which Active Role most appropriately relates to ROLE_100. At the time of choosing, the selected Active Role ID gets coalesced onto Candidate Role ROLE_100. In one example, the user chooses ROLE_23 from the potential mappings above. Role IDs are then coalesced from active roles back onto candidates, with the results for candidate roles for the example shown here.

| role_id | access patterns | entitlements |
|---|---|---|
| ROLE_23 | [[AP_1]] | [Ent_A, Ent_B, Ent_D] |
| ROLE_21 | [[AP_2]] | [Ent_A, Ent_C] |
| ROLE_22 | [[AP 3, [AP4]] | [Ent_A, Ent_B, Ent_C] |

Generally, once a set of association rules has been filtered, we gather an EntitlementSet per justification, so that each justification has a corresponding set of entitlements.

| Justification | EntitlementSet |
|---|---|
| [DF_1, DF_2] | [ENT_1, ENT_2, ENT_3] |
| [DF_3, DF_4, DF_5] | [ENT_5, ENT_6] |
| [DF_1, DF_6] | [ENT_1, ENT_2, ENT_3] |
| Proximity Modification Examples | |
| [DF_1, DF_6] | [ENT_1, ENT_2] |
| | (reduced entitlement set) |
| [DF_7, DF_8] | [ENT_1, ENT_2, ENT_3] |
| (modified justification for role) | |

With the newly gathered EntitlementSet, a JustificationSet can be produced by grouping justifications by their set of entitlements. The products of this stage form the core of candidate roles.

| | JustificationSets | |
|---|---|---|
| Role | with examples | EntitlementSet |
| R1 | [[DF_1 employee role, | [ENT_1, |
| (name) | DF_2 manager name], | ENT_2, ENT_3] |
| | [DF_1, DF_6 team]] | |
| R2 | [[DF_3, DF_4, DF_5]] | [ENT_5, ENT_6] |

The disclosed technology utilizes frequent pattern (FP) tree/grove to create role sets, of justification/entitlement/confidence level. From the mined set of Candidate Roles, we reduce the population further by discarding all Candidates that fail to meet the EntitlementMinimum threshold, as defined by the customer. As an example, an EntitlementMinimum of 3 would discard Role R2. A new FP tree is created in each cycle of justification and entitlement analysis. The FP growth algorithm tree has nodes that point to entitlements. Output of FP tree (growth) is the rule set.

Calculate confidence using frequency or count of number of instances of the pattern, with the frequency union property defined as the number of times that employees share justification union with the number of employees who have that entitlement, and justification count union entitlement count divided by the count of just justifications. That is, how many times employees have an entitlement, and divide frequency union by frequency to obtain the confidence.

The number of roles per employee is customer configurable. High confidence in roles tends to decrease the number of allowed roles. One goal is to increase a prior role approach of seventy percent coverage of standard roles toward ninety percent coverage, and then eliminating the low confidence roles. During training, a new FP tree is constructed, and new association rules are mined from that tree.

The role mine proximity algorithm takes successive runs of the role mine candidate role algorithm and establishes proximity of the newly constructed functional roles to the roles that may have already been published by the customer. Such proximity algorithms allow customers to understand if their existing published functional roles require modification to evolve with business changes.

A customer can then take these candidate roles, modify them as needed, and publish them for overall consumption by the business.

There exist roles in the mappings (most of them) that have a perfect match, bi-directionally. This means that a Candidate is a perfect and only match for a Published/Active Role and vice versa.

These mappings are retrieved by first filtering from the perspective of the Published/Active Role. Each will receive a Candidate from its mappings with the lowest corresponding proximity score. Subsequently, the mappings are filtered from the perspective of the Candidate in the same way. Each receives its lowest mapping and the authoritative one-to-one mappings have been extracted.

Customers perform three steps to utilize the disclosed technology. They run the Role Mining Job, then review the list of Candidate Roles suggested by the solution, and then analyze specific Candidate Roles and create draft roles and later publish them.

Additionally, the customer can evaluate how the constant change in access patterns affect already published roles.

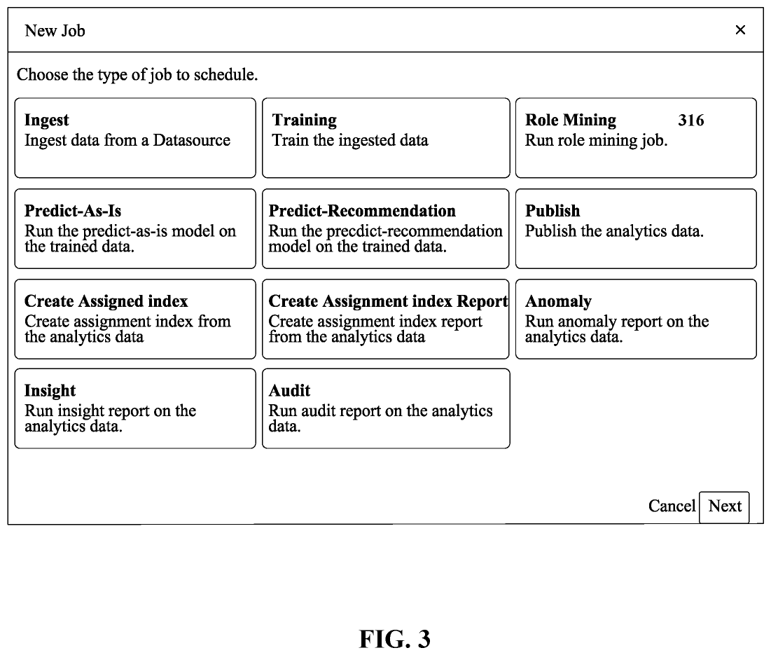

FIG. 3 illustrates a user interface for autonomous (auto) ID engine 165 that an analyst can use to create a job to run “Role Mining” 316. The Role Mining job then runs the base algorithm using configured parameters that include the minimum confidence level, minimum number of entitlements that a role can have, and minimum number of members. Once the job completes, the analysts can then go to the next step.

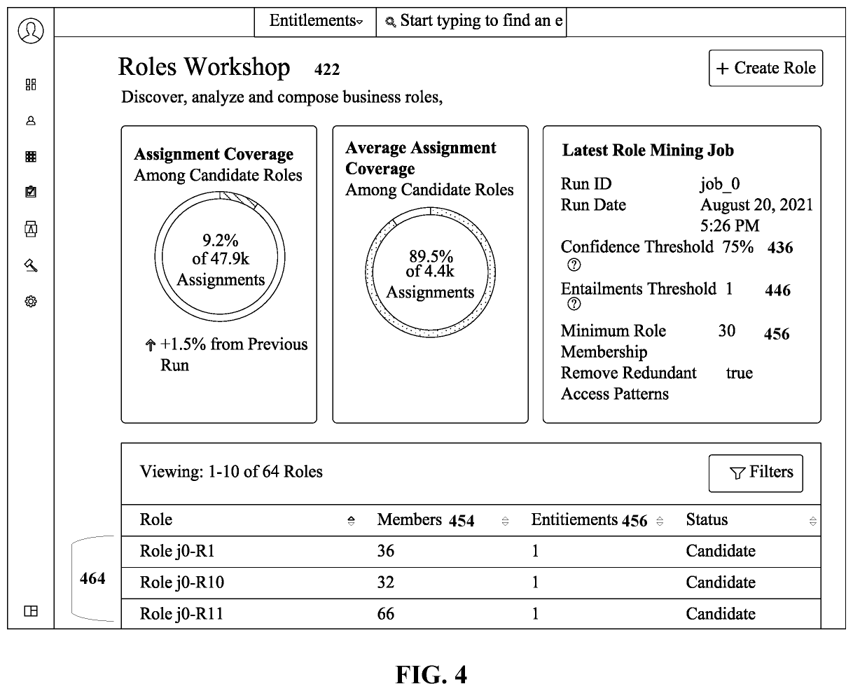

FIG. 4 shows a user interface for reviewing candidate roles, using roles workshop 422. The analyst, having run the role mining job, can view the list of candidate roles 464 suggested by the solution. Each role has the number of entitlements 456 that the role contains along with the number of members 454 that each role has. The latest role mining job stats lists the values set for the configurable confidence threshold 436, entitlements threshold 446, minimum role membership 456. Roles can be created as well, using the interface, with configurable features.

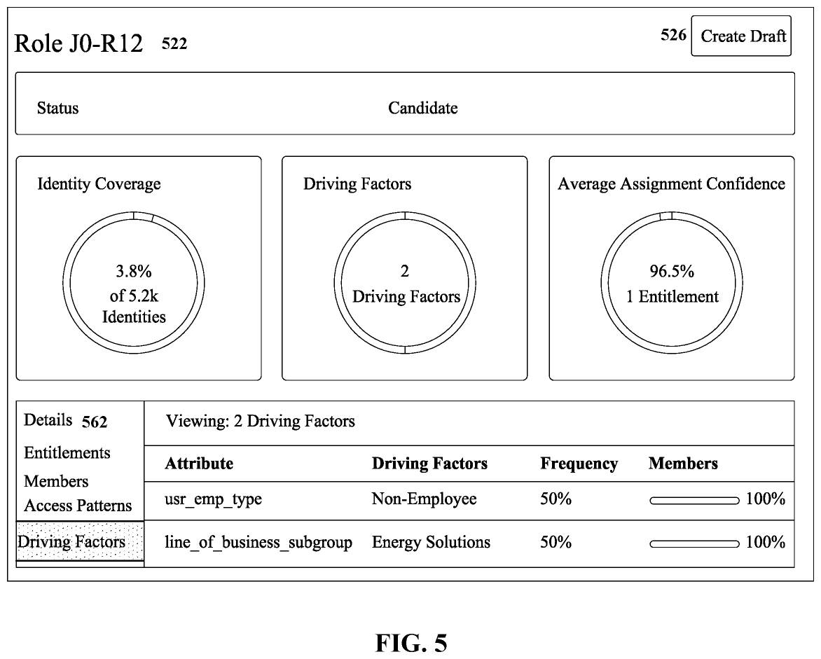

FIG. 5 illustrates a user interface for analyzing a specific role 522 for publication. After browsing the list of candidate roles 464 shown in FIG. 4, the analyst can choose one of the roles and view the details. S/he can then create a draft role 526, give it a name, and make modifications to either the entitlements or the membership rules, before publishing the role.

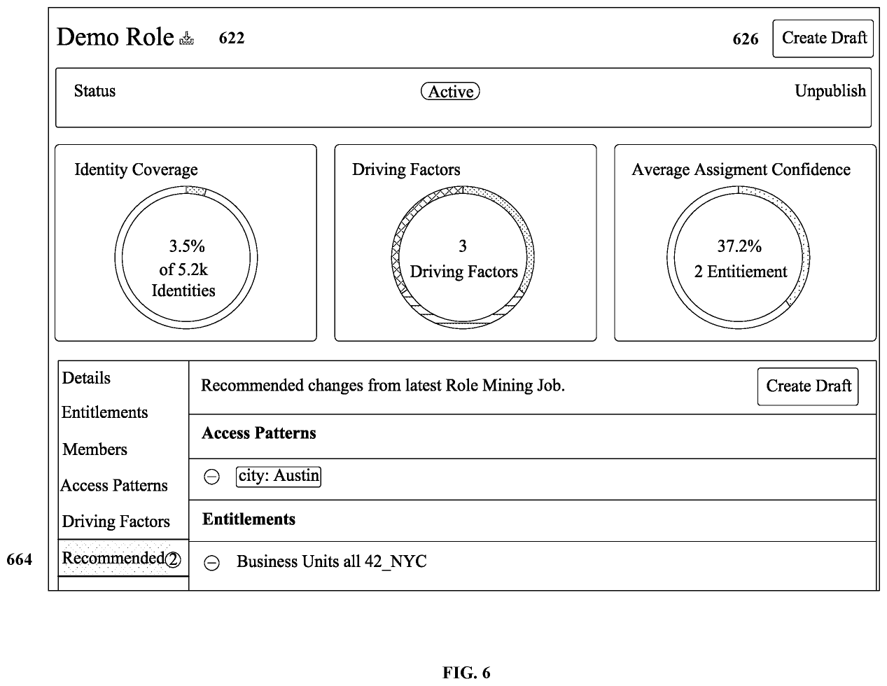

FIG. 6 shows a disclosed user interface for demonstrating roles 622, creating drafts 626 and evaluating changes to published roles. As access landscape changes, a subsequent rule of the role mining job might yield recommendations for changes 664 to already published roles. The disclosed solution runs the proximity algorithm to determine the changes needed and provides analytics to review and make changes. Administrators can visually inspect access patterns (entitlements) that may need to be added or removed.

We describe a representative computer system for coalescing candidate roles discovered by role mining with active roles that preexisted the role mining next.

### Computer System

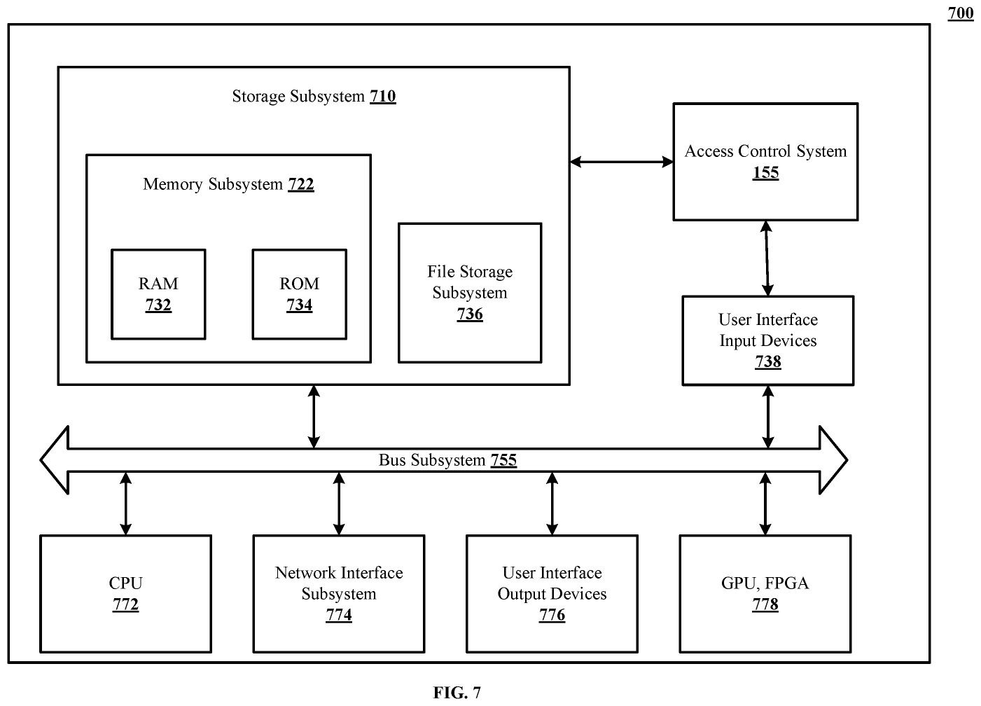

FIG. 7 is a simplified block diagram of a computer system 700 that can be used for coalescing candidate roles discovered by role mining with active roles that preexisted the role mining. Computer system 700 includes at least one central processing unit (CPU) 772 that communicates with a number of peripheral devices via bus subsystem 755, and Access Control System 155, as described herein. These peripheral devices can include a storage subsystem 710 including, for example, memory devices and a file storage subsystem 736, user interface input devices 738, user interface output devices 776, and a network interface subsystem 774. The input and output devices allow user interaction with computer system 700. Network interface subsystem 774 provides an interface to outside networks, including an interface to corresponding interface devices in other computer systems. Access Control System 155 is communicably linked to the storage subsystem 710 and the user interface input devices 738.

User interface input devices 738 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 700.

User interface output devices 776 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 700 to the user or to another machine or computer system.

Storage subsystem 710 stores programming and data constructs that provide the functionality of some or all of the modules and methods described herein. Subsystem 778 can be graphics processing units (GPUs) or field-programmable gate arrays (FPGAs).

Memory subsystem 722 used in the storage subsystem 710 can include a number of memories including a main random-access memory (RAM) 732 for storage of instructions and data during program execution and a read only memory (ROM) 734 in which fixed instructions are stored. A file storage subsystem 736 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 736 in the storage subsystem 710, or in other machines accessible by the processor.

Bus subsystem 755 provides a mechanism for letting the various components and subsystems of computer system 700 communicate with each other as intended. Although bus subsystem 755 is shown schematically as a single bus, alternative implementations of the bus subsystem can use multiple busses.

Computer system 700 itself can be of varying types including a personal computer, a portable computer, a workstation, a computer terminal, a network computer, a television, a mainframe, a server farm, a widely distributed set of loosely networked computers, or any other data processing system or user device. Due to the ever-changing nature of computers and networks, the description of computer system 700 depicted in FIG. 7 is intended only as a specific example for purposes of illustrating the preferred embodiments of the present invention. Many other configurations of computer system 700 are possible having more or fewer components than the computer system depicted in FIG. 7.

### Particular Implementations

We describe some implementations and features for coalescing candidate roles discovered by role mining with active roles that preexisted the role mining in the following discussion.

One implementation discloses a method of coalescing candidate roles discovered by role mining with active roles that preexisted the role mining, including calculating pairwise proximities between the candidate roles and the active roles by counting differences between pairs over attribute lists for entitlement, driving factors and access patterns, with a penalty for lack of overlap between attribute lists to produce a total difference score. The disclosed method also includes selecting pairs of candidate and active roles that have a low total difference scores that also are below a threshold. For the selected pairs, the method further includes proposing to assign entitlements from the active role to the paired candidate role, and receiving user feedback on whether to proceed with merging of candidate roles in the pair into corresponding active roles, while retaining entitlements of the active roles.

The methods described in this section and other sections of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this method can readily be combined with sets of base features identified as implementations.

Some implementations of the method further include role mining by finding access patterns used by more than a threshold number of users and creating candidate roles from shared groups of the access patterns.

For many implementations of the disclosed method, active roles are roles defined in the access control system with assigned entitlements. After merging of a particular candidate role with a particular active role, the users discovered by the role mining that have the particular candidate role are assigned the particular active role.

For many implementations of the method a lower total difference score indicates a higher proximity between the candidate role and the active role, and a higher total difference score indicates a lower proximity between the candidate role and the active role.

Some implementations of the disclosed method also include automatically mapping multiple candidate roles into the corresponding active roles with low total difference scores.

One implementation of the disclosed method includes a customer configurable count of functional roles per employee.

Some implementations include receiving a request for explanation of how at least one particular candidate role relates to at least one particular active role and responsively causing display of both overlaps and non-overlaps between the attribute lists of the particular candidate role and the particular active role for entitlement, driving factors and access patterns.

Other implementations of the disclosed technology described in this section can include a tangible non-transitory computer readable storage media, including program instructions loaded into memory that, when executed on processors, cause the processors to perform any of the methods described above. Yet another implementation of the disclosed technology described in this section can include a system including memory and one or more processors operable to execute computer instructions, stored in the memory, to perform any of the methods described above.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

What is claimed is:

1. A method of coalescing candidate roles discovered by role mining with active roles that preexisted the role mining in an access control system, including:
calculating pairwise proximities between the candidate roles and the active roles by counting differences between pairs over attribute lists for entitlement, driving factors and access patterns, with a penalty for lack of overlap between attribute lists to produce a total difference score;
selecting pairs of candidate and active roles that have a low total difference scores that also are below a threshold;
for the selected pairs, proposing to assign entitlements from the active role to the paired candidate role; and
receiving user feedback on whether to proceed with merging of candidate roles in the pair into corresponding active roles, while retaining entitlements of the active roles.

2. The method of claim 1, further including role mining by finding access patterns used by more than a threshold number of users and creating candidate roles from shared groups of the access patterns.

3. The method of claim 1, wherein active roles are roles defined in the access control system with assigned entitlements.

4. The method of claim 1, wherein, after merging of a particular candidate role with a particular active role, the users discovered by the role mining to have the particular candidate role are assigned the particular active role.

5. The method of claim 1, wherein a lower total difference score indicates a higher proximity between the candidate role and the active role.

6. The method of claim 1, wherein a higher total difference score indicates a lower proximity between the candidate role and the active role.

7. The method of claim 1, further including automatically merging multiple candidate roles into the corresponding active roles with a total difference score below a configurable threshold.

8. The method of claim 1, further including a customer configurable count of functional roles per employee.

9. The method of claim 1, further including receiving a request for explanation of how at least one particular candidate role relates to at least one particular active role and responsively causing display of both overlaps and non-overlaps between the attribute lists of the particular candidate role and the particular active role for entitlement, driving factors and access patterns.

10. A tangible non-transitory computer readable storage media, including program instructions loaded into memory that, when executed on processors, cause the processors to implement a method of coalescing candidate roles discovered by role mining with active roles that preexisted the role mining, the method including:
calculating pairwise proximities between the candidate roles and the active roles by counting differences between pairs over attribute lists for entitlement, driving factors and access patterns, with a penalty for lack of overlap between attribute lists to produce a total difference score;
selecting pairs of candidate and active roles that have a low total difference scores that also are below a threshold;
for the selected pairs, proposing to assign entitlements from the active role to the paired candidate role; and
receiving user feedback on whether to proceed with merging of candidate roles in the pair into corresponding active roles, while retaining entitlements of the active roles.

11. The tangible non-transitory computer readable storage media of claim 10, wherein a lower total difference score indicates a higher proximity between the candidate role and the active role.

12. The tangible non-transitory computer readable storage media of claim 10, wherein a higher total difference score indicates a lower proximity between the candidate role and the active role.

13. The tangible non-transitory computer readable storage media of claim 10, further including automatically mapping multiple candidate roles into the corresponding active roles with low total difference scores.

14. The tangible non-transitory computer readable storage media of claim 10, further including a customer configurable count of functional roles per employee.

15. The tangible non-transitory computer readable storage media of claim 10, further including role mining by finding access patterns used by more than a threshold number of users and creating candidate roles from shared groups of the access patterns.

16. A system for coalescing candidate roles discovered by role mining with active roles that preexisted the role mining, the system including a processor, memory coupled to the processor and program instructions from the non-transitory computer readable storage media of claim 10 loaded into the memory.

17. The system of claim 16, wherein the program instructions extend the method wherein a lower total difference score indicates a higher proximity between the candidate role and the active role.

18. The system of claim 16, wherein the program instructions extend the method wherein a higher total difference score indicates a lower proximity between the candidate role and the active role.

19. The system of claim 16, wherein the program instructions extend the method, further including automatically mapping multiple candidate roles into the corresponding active roles with low total difference scores.

20. The system of claim 16, wherein the program instructions extend the method, further including a customer configurable count of functional roles per employee.

21. The system of claim 16, further including role mining by finding access patterns used by more than a threshold number of users and creating candidate roles from shared groups of the access patterns.
